(19) United States
(12) Patent Application Publication
(10) Pub. No.: US 2024/0034020 A1
(43) Pub. Date: Feb. 1, 2024

(54) PRODUCTION PROCESS FOR PAPER NUT

(71) Applicant: Dongguan Fengcai Technology Co., Ltd, Guangdong (CN)

(72) Inventor: Jing He, Sichuan (CN)

(73) Assignee: Dongguan Fengcai Technology Co., Ltd, Guangdong (CN)

(21) Appl. No.: 17/958,447

(22) Filed: Oct. 3, 2022

(30) Foreign Application Priority Data
Jul. 29, 2022 (CN) 202210907166.6

(51) Int. Cl. B31D 5/00; F16B 33/00

(52) U.S. Cl. CPC B31D 5/00; F16B 33/006

(57) ABSTRACT

A production process for a paper nut, comprising: step 1, determining a diameter of the paper nut to be manufactured; step 2, preparing a metal tube or a round rod made of other material with the same diameter as a mold for determining an inner diameter of the paper nut; and step 3, selecting a first paper strip with an appropriate width, wherein the appropriate width of the first paper strip is equal to a length of being wounded around the paper tube in several turns. It is possible to freely manufacture the paper nut with internal threads or external threads according to use requirements. The case of manufacturing the paper nut with the internal threads or the external threads is according to the winding sequence of the first paper strip, the second paper strip and the third paper strip wounded around the cylindrical paper tube.

### CROSS-REFERENCE TO RELATED APPLICATION

This application claims the priority benefit of China application serial no. 202210907166.6, filed on Jul. 29, 2022. The entirety of the above-mentioned patent application is hereby incorporated by reference herein and made a part of this specification.

### BACKGROUND

### Technical Field

The present invention relates to the field of paper nut processing, and in particular to a production process for a paper nut.

### Description of Related Art

Nuts are also called screw nuts. Generally, there are many kinds of nuts, such as hexagonal nuts, round nuts, square nuts and plastic nuts. Nuts have stronger adaptabilities and meet requirements of thread sizes of male parts, so they can all be used. It can be seen that nuts are used more widely than traditional anchor bolts. The installation of nuts is simpler. Previous traditional anchor bolts were relatively complicated in installation processes, but now installation processes of nuts are relatively simple, which brings convenience to many users and reduces the problems encountered in installation of nuts. We do not need to worry about the following situation: the traditional anchor bolts will tilt when drilling. We can directly drill holes in the case of installing nuts, and then install the nuts. By doing this, the success rate can reach nearly 100%. The design of the nuts is novel, which greatly improves the aesthetics of the nuts. There is no trouble when the nuts are not in use, and threads on the nuts can ensure that the utilization degree of screws is greatly improved during installation.

In order to ensure that an inner wall or outer wall of each nut is provided with threads, people can only select plastic or metal with a certain hardness as the raw material of the nut, and use a nut mechanism to thread the plastic or metal raw material.

However, selecting plastic or metal as the raw material of nuts increases the manufacturing cost of the nuts and cannot meet the requirements of modern society for environmental protection of packaging materials, and also, there is currently no process that can make internal or external threads on paper tubes to realize paper nuts.

### SUMMARY

The object of the present invention is to provide a production process for a paper nut, in order to solve the above problems proposed in the background art that selecting plastic or metal as the raw material of nuts increases the manufacturing cost of the nuts and cannot meet the requirements of modern society for environmental protection of packaging materials, and also, there is currently no process that can make internal or external threads on paper tubes to realize paper nuts.

To achieve the above object, the present invention provides the following technical solution: a production process for a paper nut, which includes the following steps:
step 1, determining a diameter of the paper nut to be manufactured: clearly knowing a diameter of the paper nut to be manufactured before manufacturing the paper nut, for example, manufacturing the paper nut with a diameter of 5.82 mm, 8 mm, or the like;
step 2, preparing a paper tube with the same diameter as a mold for determining an inner diameter of the paper nut;
step 3, selecting a first paper strip with an appropriate width: selecting the first paper strip with the appropriate width that can be wounded around the paper tube in multiple turns of length;
step 4, winding the first paper strip around the paper tube: winding the first paper strip equidistantly and obliquely around the paper tube clockwise or counterclockwise;
step 5, selecting a second paper strip with an appropriate width: selecting the second paper strip with the appropriate width that can be wounded around the paper tube in at least two layers of length;
step 6, winding the second paper strip around the paper tube: winding the second paper strip around the paper tube clockwise or counterclockwise after covering the first paper strip;
step 7, pasting the second paper strip on the first paper strip: pasting and fixing the second paper strip to the outside of the first paper strip with glue;
step 8, selecting a third paper strip with an appropriate width: selecting the third paper strip with the appropriate width that can be wounded around the paper tube in at least two layers of length;
step 9, winding the third paper strip around the paper tube: winding the third paper strip around the paper tube clockwise or counterclockwise after covering the second paper strip;
step 10, pasting the third paper strip on the second paper strip: pasting and fixing the third paper strip to the outside of the second paper strip with glue;
step 11, shaping and drying: performing drying and shaping on a connection between the first paper strip and the second paper strip, and a connection between the second paper strip and the third paper strip after pasting;
step 12, taking off a shaped and finished product from the paper tube: sliding out the shaped and finished product from the paper tube; and
step 13, performing length cutting on the shaped and finished product: performing length cutting on the shaped and finished product with a cutting device.

As a preferred technical solution of the present invention, the paper tube in step 2 is cylindrical, and the nut needs to rotate along a bolt during tightening. This requires that during the rotation of the nut along a center line of the bolt, the mutual contact area and contact force should be consistent, so as to prevent the threads of the bolt or the nut from being damaged. Therefore, the inner wall of the manufactured nut must be cylindrical.

As a preferred technical solution of the present invention, in step 4, the first paper strip is wound equidistantly and obliquely around the paper tube clockwise or counterclockwise, and the number of turns of the first paper strip is greater than or equal to the number of required threads.

As a preferred technical solution of the present invention, in step 5, with regard to the second paper strip with the appropriate width, the width of the second paper strip is greater than the width of the first paper strip, such that the second paper strip wound around in one turn can wrap the first paper strip wound around the paper tube in multiple turns.

As a preferred technical solution of the present invention, in step 6, the second paper strip is wound around the paper tube clockwise or counterclockwise after covering the first paper strip, in which the second paper strip is wound in at least two layers in a staggered manner.

As a preferred technical solution of the present invention, in step 8, with regard to the third paper strip with the appropriate width, the width of the third paper strip is greater than the width of the second paper strip, such that the third paper strip wound around in one turn can wrap the second paper strip wound around the paper tube in multiple turns.

As a preferred technical solution of the present invention, in step 9, the third paper strip is wound around the paper tube clockwise or counterclockwise after covering the second paper strip, in which the third paper strip is wound in at least two layers in a staggered manner.

Compared with the prior art, the beneficial effects of the present invention are as follows:
1. The whole nut adopts paper as the raw material, which can be used for secondary utilization of waste paper after use, which can save a lot of fiber raw materials for pulping and paper-making, and the saved fiber raw materials can increase the output of pulp and paper, thus meeting the needs of people's life and industry. This can not only cut down less trees, which is beneficial to closing hillsides for afforestation, soil and water conservation and ecological environment protection, but also reduce the pollution of waste paper to the environment.
2. An operator can freely manufacture a nut with internal threads or external threads according to use requirements. In the case of manufacturing the nut with the internal threads, the first paper strip, the second paper strip and the third paper are sequentially wound around the cylindrical paper tube. In the case of manufacturing the nut with the external threads, the third paper strip, the second paper strip and the first paper strip are sequentially wound around the cylindrical paper tube. Only the winding sequence is changed, which replaces the traditional step of thread processing by using a nut mechanism, thus reducing the manufacturing cost of the nut.
3. The nut is provided in a cylindrical shape. The nut needs to rotate along a bolt during tightening. This requires that during the rotation of the nut along a center line of the bolt, the mutual contact area and contact force should be consistent, so as to prevent the threads of the bolt or the nut from being damaged and prolong the service life of the paper nut.

### DESCRIPTION OF THE EMBODIMENTS

The technical solution in the embodiments of the present invention will be clearly and completely described below in conjunction with the embodiments of the present invention; and obviously, the embodiments described are merely some, rather than all, of the embodiments of the present invention. On the basis of the embodiments of the present invention, all other embodiments obtained by those of ordinary skill in the art without creative efforts shall fall within the scope of protection of the present invention.

The present invention provides a production process for a paper nut, which including the following steps:
step 1, determining a diameter of a nut to be manufactured: clearly knowing a diameter of a nut to be manufactured before manufacturing the nut, for example, manufacturing a nut with a diameter of 5.82 mm, 8 mm, or the like;
step 2, preparing a paper tube with the same diameter as a mold for determining an inner diameter of the nut;
step 3, selecting a first paper strip with an appropriate width: selecting a first paper strip with an appropriate width that can be wound around the paper tube in multiple turns of length;
step 4, winding the first paper strip around the paper tube: winding the first paper strip equidistantly and obliquely around the paper tube clockwise or counterclockwise;
step 5, selecting a second paper strip with an appropriate width: selecting a second paper strip with an appropriate width that can be wound around the paper tube in two layers of length;
step 6, winding the second paper strip around the paper tube: winding the second paper strip around the paper tube clockwise or counterclockwise after covering the first paper strip;
step 7, pasting the second paper strip on the first paper strip: pasting and fixing the second paper strip to the outside of the first paper strip with glue;
step 8, selecting a third paper strip with an appropriate width: selecting a third paper strip with an appropriate width that can be wound around the paper tube in two layers of length;
step 9, winding the third paper strip around the paper tube: winding the third paper strip around the paper tube clockwise or counterclockwise after covering the second paper strip;
step 10, pasting the third paper strip on the second paper strip: pasting and fixing the third paper strip to the outside of the second paper strip with glue;
step 11, shaping and drying: performing drying and shaping on a connection between the first paper strip and the second paper strip, and a connection between the second paper strip and the third paper strip after pasting;
step 12, taking off a finished product from the paper tube: sliding out a shaped and finished product from the paper tube; and
step 13, performing length cutting on the finished product: performing length cutting on the shaped and finished product with a cutting device.

The paper tube in step 2 is cylindrical, and the nut needs to rotate along a bolt during tightening. This requires that during the rotation of the nut along a center line of the bolt, the mutual contact area and contact force should be consistent, so as to prevent the threads of the bolt or the nut from being damaged. Therefore, the inner wall of the manufactured nut must be cylindrical.

In step 4, the first paper strip is wound equidistantly and obliquely around the paper tube

clockwise or counterclockwise, and the number of turns of the first paper strip is greater than or equal to the number of required threads.

In step 5, with regard to the second paper strip with the appropriate width, the width of the second paper strip is greater than the width of the first paper strip, such that the second paper strip wound around in one turn can wrap the first paper strip wound around the paper tube in multiple turns.

In step 6, the second paper strip is wound around the paper tube clockwise or counterclockwise after covering the first paper strip, in which the second paper strip is wound in at least two layers in a staggered manner.

In step 8, with regard to the third paper strip with the appropriate width, the width of the third paper strip is greater than the width of the second paper strip, such that the third paper strip wound around in one turn can wrap the second paper strip wound around the paper tube in multiple turns.

In step 9, the third paper strip is wound around the paper tube clockwise or counterclockwise after covering the second paper strip, in which the third paper strip is wound in at least two layers in a staggered manner.

When the present invention is used: in the case of manufacturing a nut with internal threads, an operator should clearly know a diameter of a nut to be manufactured before manufacturing the nut, for example, manufacturing a nut with a diameter of 5.82 mm, 8 mm, or the like, and prepare a cylindrical paper tube with the same diameter as the nut to be manufactured as a mold for determining an inner diameter of the nut. The nut needs to rotate along a bolt during tightening. This requires that during the rotation of the nut along a center line of the bolt, the mutual contact area and contact force should be consistent, so as to prevent the threads of the bolt or the nut from being damaged. Therefore, the inner wall of the manufactured nut must be cylindrical. The operator selects a first paper strip with an appropriate width that can be wound around the paper tube in multiple turns of length, and winds the first paper strip equidistantly and obliquely around the paper tube clockwise or counterclockwise with the number of turns of the first paper strip being greater than or equal to the number of required threads, so as to meet the requirement of providing threads on the manufactured nut. The operator selects a second paper strip with an appropriate width that can be wound around the paper tube in two layers of length with the width of the second paper strip being greater than the width of the first paper strip, such that the second paper strip wound around in one turn can wrap the first paper strip wound around the paper tube in multiple turns. The second paper strip is wound around the paper tube clockwise or counterclockwise after covering the first paper strip, in which the second paper strip is wound in at least two layers in a staggered manner. The inner side of the second paper strip is covered with glue, and the second paper strip is pasted and fixed to the outside of the first paper strip with the glue. The operator selects a third paper strip with an appropriate width that can be wound around the paper tube in two layers of length, such that the third paper strip wound around in one turn can wrap the second paper strip wound around the paper tube in multiple turns. The third paper strip is wound around the paper tube clockwise or counterclockwise after covering the second paper strip, in which the third paper strip is wound in at least two layers in a staggered manner. The inner side of the third paper strip is covered with glue, and the third paper strip is pasted and fixed to the outside of the second paper strip with the glue. The operator performs, with a shaping and drying device, drying and shaping on a connection between the first paper strip and the second paper strip, and a connection between the second paper strip and the third paper strip after pasting. The operator slides out a shaped and finished product from the cylindrical paper tube. The operator performs length cutting on the shaped and finished product with a cutting device. Then the manufacturing of the paper nut is completed. In the case of manufacturing a nut with external threads, the operator should clearly know a diameter of a nut to be manufactured before manufacturing the nut. The operator selects a cylindrical paper tube with the same diameter. The operator first winds the third paper strip around the paper tube, then winds the second paper strip, and finally winds the first paper strip. The first paper strip is pasted on the second paper strip with glue, and the second paper strip is pasted on the third paper strip. The operator performs, with the shaping and drying device, drying and shaping on a connection between the first paper strip and the second paper strip, and a connection between the second paper strip and the third paper strip after pasting. The operator slides out a shaped and finished product from the cylindrical paper tube. The operator performs length cutting on the shaped and finished product with the cutting device. Then the manufacturing of the paper nut is completed.

Although the present invention has been described in detail with reference to the foregoing embodiments, for those skilled in the art, the technical solution recorded in the foregoing embodiments may still be modified, or some technical features therein may be equivalently replaced. Any modifications, equivalent replacements, improvements, and the like made within the spirit and principle of the present invention shall be included into the scope of protection of the present invention.

What is claimed is:

1. A production process for a paper nut, comprising:
step 1, determining a diameter of the paper nut to be manufactured;
step 2, preparing a paper tube with a diameter, wherein the diameter of the paper tube is the same as a diameter of a mold for determining an inner diameter of the paper nut;
step 3, selecting a first paper strip with an appropriate width, wherein the appropriate width of the first paper strip is equal to a length of being wounded around the paper tube in several turns;
step 4, winding the first paper strip equidistantly and obliquely around the paper tube clockwise or counterclockwise;
step 5, selecting a second paper strip with an appropriate width, wherein the appropriate width of the second paper strip is equal to a length of being wounded around the paper tube in at least two layers;
step 6, winding the second paper strip around the paper tube clockwise or counterclockwise after winding the first paper strip around the paper tube;
step 7, pasting and fixing the second paper strip to a side of the first paper strip relative to the paper tube;
step 8, selecting a third paper strip with an appropriate width, wherein the appropriate width of the third paper strip is equal to a length of being wounded around the paper tube in at least two layers;
step 9, winding the third paper strip around the paper tube clockwise or counterclockwise after winding the second paper strip around the paper tube;
step 10, pasting and fixing the third paper strip to a side of the second paper strip relative to the paper tube;
step 11, performing drying and shaping on a connection between the first paper strip and the second paper strip after pasting the second paper strip to the first paper strip, and performing drying and shaping on a connection between the second paper strip and the third paper strip after pasting the third paper strip to the second paper strip;
step 12, sliding out and taking off a shaped and finished product from the paper tube, wherein the shaped and finished product comprises the first paper strip, the second paper strip, and the third paper strip; and
step 13, performing length cutting on the shaped and finished product with a cutting device.

2. The production process for the paper nut according to claim 1, wherein the paper tube in the step of preparing the paper tube with the diameter is cylindrical.

3. The production process for the paper nut according to claim 1, wherein in the step of winding the first paper strip equidistantly and obliquely around the paper tube clockwise or counterclockwise, the first paper strip is wounded equidistantly and obliquely around the paper tube clockwise or counterclockwise in the several turns, and the number of the several turns of the first paper strip wounded around the paper tube is greater than or equal to the number of required threads.

4. The production process for the paper nut according to claim 1, wherein in the step of selecting the second paper strip with the appropriate width, the appropriate width of the second paper strip is greater than the appropriate width of the first paper strip.

5. The production process for the paper nut of claim 1, wherein in the step of winding the second paper strip around the paper tube clockwise or counterclockwise after winding the first paper strip around the paper tube, the second paper strip is wounded around the paper tube in the at least two layers and is in a staggered manner.

6. The production process for a paper nut according to claim 1, wherein in the step of selecting the third paper strip with the appropriate width, the appropriate width of the third paper strip is greater than the appropriate width of the second paper strip.

7. The production process for the paper nut according to claim 1, wherein in the step of winding the third paper strip around the paper tube clockwise or counterclockwise after winding the second paper strip around the paper tube, the third paper strip is wounded around the paper tube in the at least two layers and is in a staggered manner.
